(19) United States
(12) Patent Application Publication
(10) Pub. No.: US 2004/0045606 A1
(43) Pub. Date: Mar. 11, 2004

(54) Seal assembly for an air pump embedded in an inflated ball

(76) Inventor: Hsi-Kung Yang, Taipei Hsien (TW)

Correspondence Address: Rabin & Berdo, P.C., Suite 500, 1101 14th Street, Washington, DC, 20005, US

(21) Appl. No.: 10/237,927

(22) Filed: Sep. 10, 2002

(51) Int. Cl. F16K 15/00

(52) U.S. Cl. 137/512.15

(57) ABSTRACT

A seal assembly for an air pump having a barrel, a piston slidably received in the barrel has a cylindrical seal adapted to be received in a nozzle of the barrel and having a flat portion and a head provided with a passage adapted to selectively communicate with the nozzle of the barrel and a space in the flat portion and a circular seal sandwiched between a baffle plate and the flat portion of the cylindrical seal. The circular seal has holes selectively communicating with the space of the flat portion of the cylindrical seal and the through hole of the baffle plate and a boss detachably received in the through hole so that when the boss is received in the through hole, communication of the nozzle, the passage, the space and the through is blocked.

### BACKGROUND OF THE INVENTION

1. Field of the Invention

The present invention relates to a seal assembly for an air pump, and more particularly to a seal assembly for an air pump embedded in an inflated ball to smoothen air flow into the ball and to prevent air leakage from the ball.

2. Description of Related Art

A conventional air pump which is embedded in an inflated ball is provided with a barrel, a piston movably received in the barrel so as to force air out of the barrel and into the barrel. In order to prevent air in the ball flowing into the air pump from the ball, the air pump has a unidirectional seal provided at the nozzle of the air pump so that when the air is flowing out of the air pump and into the ball, the seal allows the smooth pass of the air flow and when air is trying to flow into the air pump from the ball, the unidirectional seal prevents the “backflow” of the air. However, using only one unidirectional seal to prevent leakage during the entire air pumping process seems not adequate since the unidirectional seal will be gradually worn during the operation such that a leakage occurs.

To overcome the shortcomings, the present invention tends to provide an improved seal assembly to mitigate and obviate the aforementioned problems.

### SUMMARY OF THE INVENTION

The primary objective of the present invention is to provide an improved seal assembly for an air pump embedded in an inflated ball. The seal assembly includes a cylindrical seal with a passage defined therein and a circular seal with holes defined to communicate with the passage and a boss detachably received in a through hole in the air pump so that when the boss is received in the through hole, air flow from outside the air pump is not able to flow into the air pump and when the boss is not in the through hole, air is able to flow smoothly out of the air pump.

Another objective of the present invention is that the cylindrical seal has a head with a diameter smaller than a diameter of the nozzle such that when pressure outside the air pump is applied onto the head, the passage is closed due to the resilience of the material for the cylindrical seal.

Other objects, advantages and novel features of the invention will become more apparent from the following detailed description when taken in conjunction with the accompanying drawings.

### BRIEF DESCRIPTION OF THE DRAWINGS

FIG. 1 is an enlarged cross sectional view of the air pump with the seal assembly received in a front portion of the air pump;

FIG. 2 is a perspective view of the seal assembly;

FIG. 3 is a schematic view showing the movement of the circular seal inside the barrel when air is flowing out of the air pump; and

FIG. 4 is a schematic view showing the deformation of the cylindrical seal when the piston is pushed to the topmost end in the barrel; and

FIG. 5 is a schematic view showing the movement of the circular seal relative to the barrel when air is trying to flow into the air pump.

### DETAILED DESCRIPTION OF THE PREFERRED EMBODIMENT

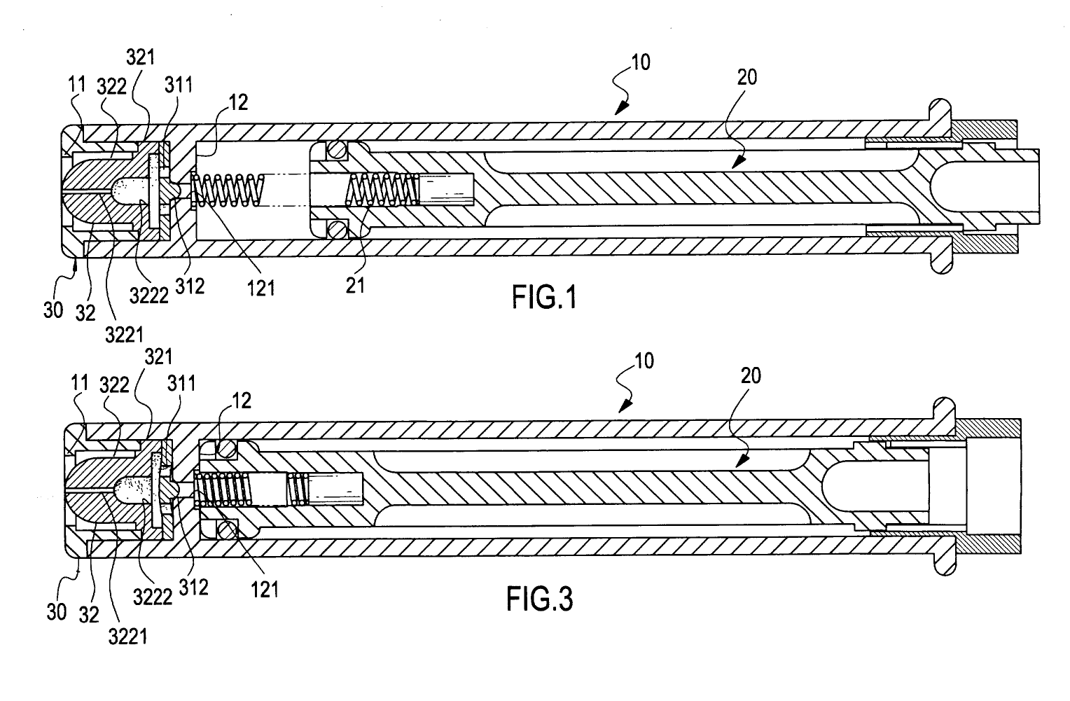

With reference to FIG. 1, the air pump in accordance with the present invention includes a barrel (10), a piston (20) slidably received in the barrel (10) and a seal assembly (30) received in a nozzle (11) of the barrel (10).

The barrel (10) has a baffle plate (12) formed on an inner periphery of the baffle (10) and having a through hole (121) defined in a center of the baffle plate (12). The piston (20) has a spring (21) partially received inside the piston (20) and partially extending out of the piston (20) to detachably engage with a face of the baffle plate (12) so as to provide a recoil force to the piston (20) when the spring (21) is compressed due to the forward movement of the piston (20) relative to the barrel (10).

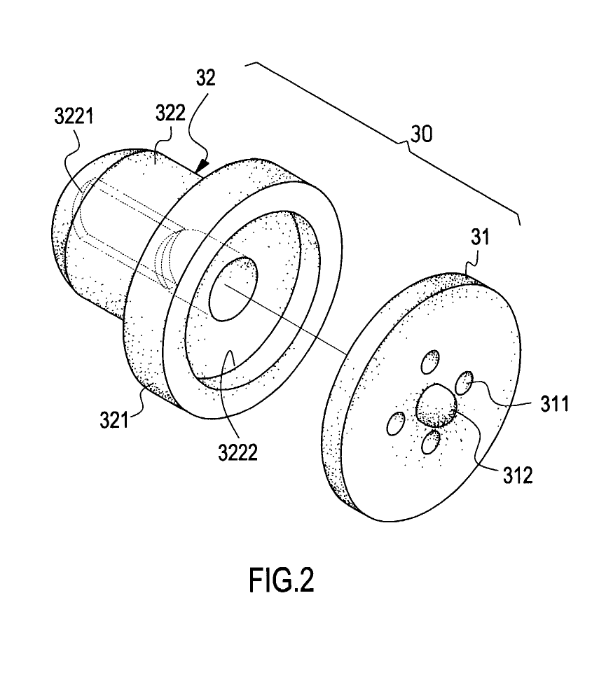

With reference to FIG. 2, the seal assembly (30) includes a circular seal (31) and a cylindrical seal (32). The circular seal (31) has holes (311) defined through the circular seal (31) and a boss (312) formed on a center of the circular seal (31) to correspond to the through hole (121) of the barrel (10). The cylindrical seal (32) has a flat portion (321) abutted to a face of the circular seal (31) and a head (322) integrally formed with the flat portion (321) and having a passage (3221) defined to communicate with a space (3222) in the cylindrical seal (32).

With reference to FIG. 3 and taking FIG. 1 for reference, when the seal assembly (30) of the present invention is received in the air pump, it is noted that the circular seal (31) abuts a face of the baffle plate (12) and the flat portion (321) abuts the circular seal (31). Furthermore, the head (322) has a diameter smaller than a diameter of the nozzle (11).

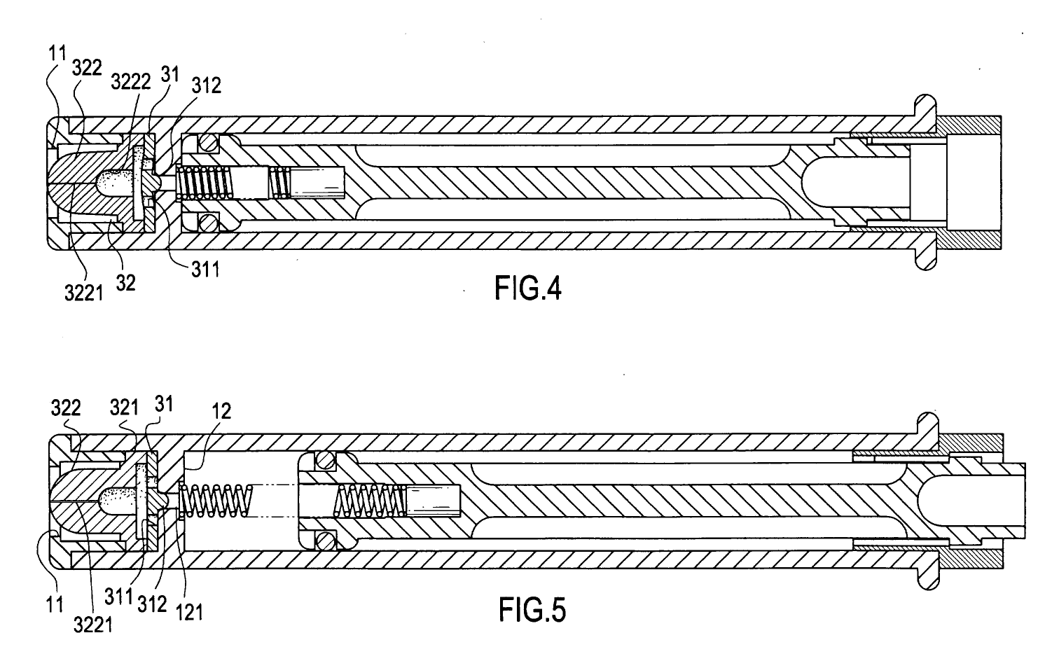

With reference to FIGS. 4 and 5, after the assembly of the seal assembly (30) in the air pump and when the piston (20) starts to move inside the barrel (10) to the nozzle (11), due to the pressure built up inside the space defined between the piston (20) and the baffle plate (12) in the barrel (10), the boss (312) is deformed toward the space (3222), which results in that the air inside the barrel (10) is able to flow through the holes (311) in the circular seal (31), the space (3222) in the flat portion (321) and into the passage (3221) in the head (322). Because the passage (3221) communicates with the nozzle (11), the air flowing into the passage (3221) is able to flow out of the nozzle (11) and then into the ball (not shown).

Still, after the air is pumped out of the air pump, pressure outside the air pump is larger than the pressure inside of the air pump, such that the head (322) is forced by the pressure outside the air pump so that the passage (3221) is closed due to the deformation of the head (322). Thus, air inside the ball can not leak through the closed passage (3221). However, if the cylindrical seal (32) is worn due to long term use and the passage (3221) is not able to be closed completely by the deformation of the head (322), pressure inside the ball will force air into the passage (3221) and then force the circular seal (31) to move further toward the piston (20). As a consequence of the movement of the circular seal (31), the boss (312) is forced to be inserted into the through hole (121) in the baffle plate (12) so as to stop any leakage of the air in the ball through the air pump during the air pumping process.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An air pump embedded in an inflated ball, the air pump comprising
a barrel with a baffle plate formed on an inner periphery of the baffle and having a through hole defined in a center of the baffle plate, a nozzle defined in a frontmost end of the barrel and a through hole defined in a center of the baffle plate;
a piston slidably received in the barrel and having a spring mounted on a front face of the piston to detachably engage with a face of the baffle plate to provide a recoil force to the piston when the spring is compressed due to a forward movement of the piston relative to the barrel; and
a seal assembly received in the nozzle of the barrel and having a cylindrical seal, wherein the cylindrical seal has a flat portion and a head integrally formed with the flat portion and having a passage defined to selectively communicate with a space in the flat portion, the through hole of the baffle plate and the nozzle,
whereby when the piston is moving toward the nozzle, pressure inside the air pump is larger than pressure outside the air pump, thus air is forced out of the air pump through the passage and the nozzle and when pressure outside the air pump is larger than pressure inside the air pump, communication between the passage and the space of the cylindrical seal is blocked to prevent leakage.

2. The air pump as claimed in claim 1, wherein the head of the cylindrical seal has a diameter smaller than a diameter of the nozzle so that the head is able to be deformed to close the passage.

3. The air pump as claimed in claim 1 further comprising a circular seal sandwiched between the baffle plate and the flat portion of the cylindrical seal, wherein the circular seal has holes selectively communicating with the space of the flat portion of the cylindrical seal and the through hole of the baffle plate and a boss detachably received in the through hole so that when the boss is received in the through hole, communication of the nozzle, the passage, the space and the through is blocked.

4. The air pump as claimed in claim 2 further comprising a circular seal sandwiched between the baffle plate and the flat portion of the cylindrical seal, wherein the circular seal has holes selectively communicating with the space of the flat portion of the cylindrical seal and the through hole of the baffle plate and a boss detachably received in the through hole so that when the boss is received in the through hole, communication of the nozzle, the passage, the space and the through is blocked.

5. A seal assembly for an air pump embedded in an inflated ball and having a barrel, a piston slidably received in the barrel, the seal assembly comprising:
a cylindrical seal adapted to be received in a nozzle of the barrel and having a flat portion and a head integrally formed with the flat portion and having a passage adapted to selectively communicate with the nozzle of the barrel and a space in the flat portion,
whereby when the piston is moving toward the nozzle, pressure inside the barrel is larger than pressure outside the air pump and thus air is forced out of the air pump through the passage and the nozzle, and
when the pressure outside the air pump is larger than the pressure inside the air pump, communication between the passage and the space of the cylindrical seal is blocked by the deformation of the head to prevent leakage.

6. The seal assembly as claimed in claim 5, wherein the head of the cylindrical seal has a diameter smaller than a diameter of the nozzle so that the head is able to be deformed to close the passage.

7. The air pump as claimed in claim 5 further comprising a circular seal adapted to be sandwiched between the baffle plate and the flat portion of the cylindrical seal, wherein the circular seal has holes adapted to selectively communicate with a through hole of the baffle plate and communicate with the space of the flat portion of the cylindrical seal and a boss adapted to be detachably received in the through hole so that when the boss is received in the through hole, communication of the nozzle, the passage, the space and the through is blocked.

8. The air pump as claimed in claim 6 further comprising a circular seal adapted to be sandwiched between the baffle plate and the flat portion of the cylindrical seal, wherein the circular seal has holes adapted to selectively communicate with a through hole of the baffle plate and communicate with the space of the flat portion of the cylindrical seal and a boss adapted to be detachably received in the through hole so that when the boss is received in the through hole, communication of the nozzle, the passage, the space and the through is blocked.
